(19) United States
(12) Patent Application Publication
(10) Pub. No.: US 2025/0360599 A1
(43) Pub. Date: Nov. 27, 2025

(54) LIMITING MECHANISM WITH IMPROVED SPACE EFFICIENCY

(71) Applicants: Asphetek Solution (Chengdu) Ltd., Chengdu (CN); Asphetek Solution Inc., Hsinchu (TW)

(72) Inventors: HSIANG TSAI, Hsinchu (TW); CHUNG-WU LIU, Hsinchu (TW); YU-PI KUO, Hsinchu (TW)

(21) Appl. No.: 18/810,982

(22) Filed: Aug. 21, 2024

(30) Foreign Application Priority Data
May 22, 2024 (CN) 202421127988.3

(51) Int. Cl. B25B 5/04

(52) U.S. Cl. CPC B25B 5/04

(57) ABSTRACT

A limiting mechanism includes a base, a transmission seat, an elastic component, a crank assembly and a limiting member. The base has a bearing portion to support the product. The transmission seat is slidable on the base. The elastic component connects the base and the seat. The crank assembly is rotatably connected to the seat and its end moves with the seat. The limiting member is linked and limits the product.

### FIELD

The subject matter herein generally relates to a device for restricting the movement of products during production and assembly processes, and more particularly, to a limiting mechanism with improved space efficiency.

### BACKGROUND

Clamping mechanisms are used to fix products. On some occasions, the clamping mechanism needs to fix the product in a limited space. However, existing clamping mechanisms may have a complex structure, and cannot be used in the limited space. Therefore, there is room for improvement within the art.

### BRIEF DESCRIPTION OF THE DRAWINGS

Implementations of the present technology will now be described, by way of example only, with reference to the attached figures.

FIG. 1 is a diagrammatic view of a limiting mechanism according to an embodiment of the present application.

FIG. 2 is a diagrammatic view of the limiting mechanism shown in FIG. 1, showing a limiting member moving away from a bearing portion.

FIG. 3 is a diagrammatic view of a limiting mechanism according to another embodiment of the present application.

### DETAILED DESCRIPTION

It will be appreciated that for simplicity and clarity of illustration, where appropriate, reference numerals have been repeated among the different figures to indicate corresponding or analogous members. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain portion may be exaggerated to better illustrate details and features of the present disclosure.

The term “comprising,” when utilized, means “including, but not necessarily limited to;” it specifically indicates open-ended inclusion or membership in the so-described combination, group, series, and the like.

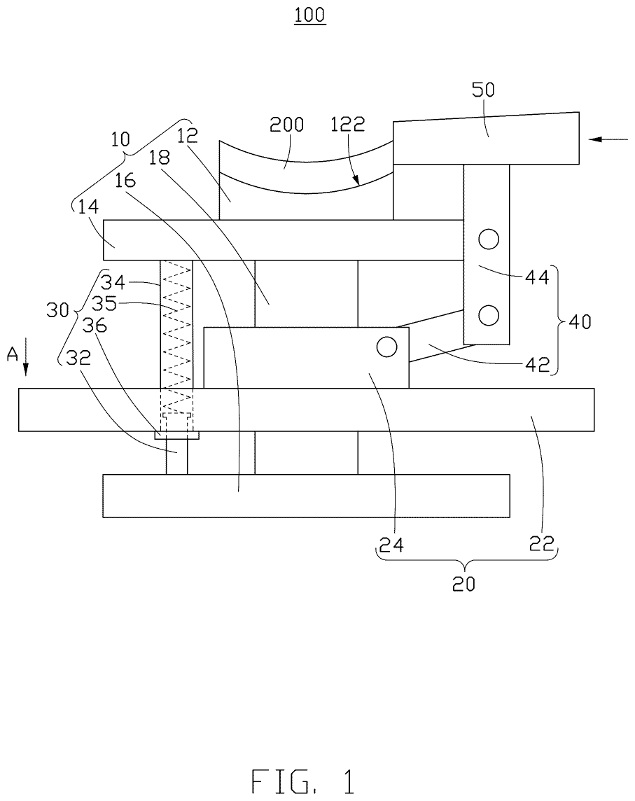

Referring to FIG. 1, a limiting mechanism 100 is provided according to an embodiment of the present disclosure. The limiting mechanism 100 is used to restrict the movement of a product 200 in a limited space. The product 200 may be a concave lens, a convex lens, or other similar objects. The limiting mechanism 100 includes a base 10, a transmission seat 20, an elastic component 30, a crank assembly 40, and a limiting member 50.

The base 10 includes a bearing portion 12 configured to support the product 200. The bearing portion 12 can match the product 200 in shape. The transmission seat 20 is slidably disposed on the base 10. The transmission seat 20 is capable of sliding on the base 10 to move closer to or away from the bearing portion 12.

The elastic component 30 is connected between the base 10 and the transmission seat 20. The elastic component 30 can be compressed by the transmission seat 20 and further rebound to push the transmission seat 20. The crank assembly 40 is rotatably connected to the transmission seat 20 and the base 10. One end of the crank assembly 40 is extended to one side of the bearing portion 12. When the transmission seat 20 slides on the base 10, the crank assembly 40 can synchronously move with the transmission seat 20, thereby causing one end of the crank assembly 40 to move closer to or away from the bearing portion 12.

The limiting member 50 is connected to the end of the crank assembly 40. The limiting member 50 synchronously moves with the crank assembly 40 to approach or move away from the bearing portion 12, thereby restricting the product 200 at the bearing portion 12. The side of the bearing portion 12 facing away from the transmission seat 20 defines a groove 122 matching the product 200.

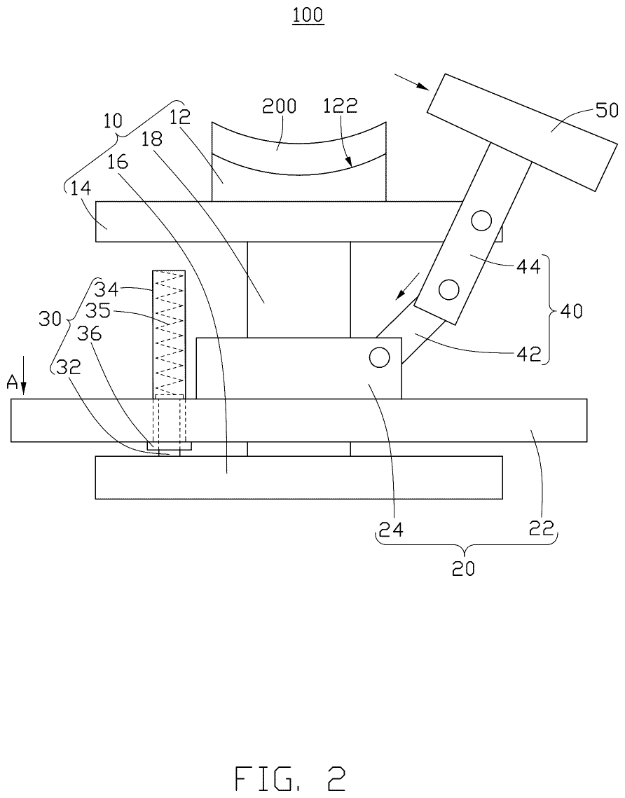

Referring to FIG. 2, when in use, the transmission seat 20 is pressed away from the bearing portion 12 in a first direction A via a force, the transmission seat 20 compresses the elastic component 30 and drive the crank assembly 40 to move, the crank assembly 40 drives the limiting member 50 to move away from the bearing portion 12, thereby allowing the product 200 to be placed on the bearing portion 12. After placing the product 200 on the bearing portion 12, the force on the transmission seat 20 is removed. The elastic component 30 then rebounds to push the transmission seat 20 along a direction opposite to the first direction A, which in turn causes the crank assembly 40 to move closer to the bearing portion 12, thereby moving the limiting member 50 to restrict the product 200.

The bearing portion 12 may be circular, and one side of the limiting member 50 that contacts the product 200 may be arcuate or semi-circular.

In this embodiment, the base 10 further includes a first plate 14, a second plate 16, and a supporting member 18. The first plate 14 and the second plate 16 are substantially identical in shape. The first plate 14 faces the second plate 16. The supporting member 18 is connected between the first plate 14 and the second plate 16, forming a generally I-shaped structure. The bearing portion 12 is connected to a side of the first plate 14 that faces away from the second plate 16. The transmission seat 20 is slidably disposed on the supporting member 18 and positioned between the first plate 14 and the second plate 16. The elastic component 30 is connected between the second plate 16 and the transmission seat 20. The crank assembly 40 is rotatably connected to both the transmission seat 20 and the first plate 14 of the base 10. Thus, the base 10 can have a stable and balance structure, and can be prevented from being titled due to irregular movements of the crank assembly 40.

The transmission seat 20 includes a base plate 22 and a connecting plate 24. The base plate 22 is slidably disposed on the supporting member 18 of the base 10. The connecting plate 24 is slidably disposed on the supporting member 18 and connected to a side of the base plate 22 facing the bearing portion 12. A cross-section of the connecting plate 24 perpendicular to a sliding direction of the transmission seat 20 is smaller than a cross-section of the base plate 22 perpendicular to a sliding direction of the transmission seat 20, forming a generally inverted T-shaped structure. The elastic component 30 is connected between the second plate 16 and the base plate 22. The crank assembly 40 is rotatably connected to both the connecting plate 24 of the transmission seat 20 and the first plate 14 of the base 10.

In this embodiment, the elastic component 30 includes a fixing rod 32, a sliding rod 34, and an elastic element 35. One end of the fixing rod 32 is connected to the second plate 16 of the base 10. The sliding rod 34 has a hollow structure and a diameter greater than that of the fixing rod 32. One end of the sliding rod 34 is slidably sleeved on the other end of the fixing rod 32. The sliding rod 34 is connected to the transmission seat 20, the other end extending towards the bearing portion 12 or the first plate 14. The elastic element 35 is disposed within the sliding rod 34 and abuts against the other end of the fixing rod 32. When a force facing downward is applied to the base plate 22, the sliding rod 34 slides along the fixing rod 32, thereby compressing the elastic element 35. When the force is removed, the elastic element 35 rebounds, moving the sliding rod 34 and the base plate 22 upward, thereby moving the connecting plate 24 upward.

In this embodiment, the elastic component 30 further includes a abutting member 36, and the abutting member 36 is connected to an end of the sliding rode 34 facing the fixing rod 32. The abutting member 36 is located on one side of the base plate 22 of the transmission seat 20 opposite to the bearing part portion 12. The diameter of the abutting member 36 is greater than that of the sliding rode 34. Thus, the base plate 22 can move downward via the abutting member 36 to press on the sliding rode 34, and allows the sliding rode 34 to move upward via the abutting member 36 to move the base plate 22. In this embodiment, the abutting member 36 and the sliding rode 34 may be integrally formed.

The crank assembly 40 includes a first rod 42 and a second rod 44. One end of the first rod 42 is rotatably connected to the connecting plate 24 of the transmission seat 20. Another end of the first rod 42 is rotatably connected to one end of the second rod 44. A middle portion of the second rod 44 is rotatably connected to the first plate 14 of the base 10. The other end of the second rod 44 extends to one side of the bearing portion 12 and is connected to the limiting member 50 vertically. When the transmission seat 20 moves downward, the first rod 42 moves downward, thereby pulling the second rod 44 downward and away from the bearing portion 12. When the transmission seat 20 moves upward, the first rod 42 pushes the second rod 44 towards the bearing portion 12.

In this embodiment, one side of the limiting member 50 facing away from the crank assembly 40 is an inclined surface in relative to another side of the limiting member 50 facing the crank assembly 40. The limiting member 50 is trapezoidal, and a cross-section of a side facing the bearing portion 12 is smaller than a cross-section of a side facing away from the bearing portion 12. Thus, the limiting member 50 can maintain balance and does not excessively press against the product 200 in the bearing portion 12. Additionally, the inclined surface helps the limiting member 50 to move away from the bearing portion 12 more easily.

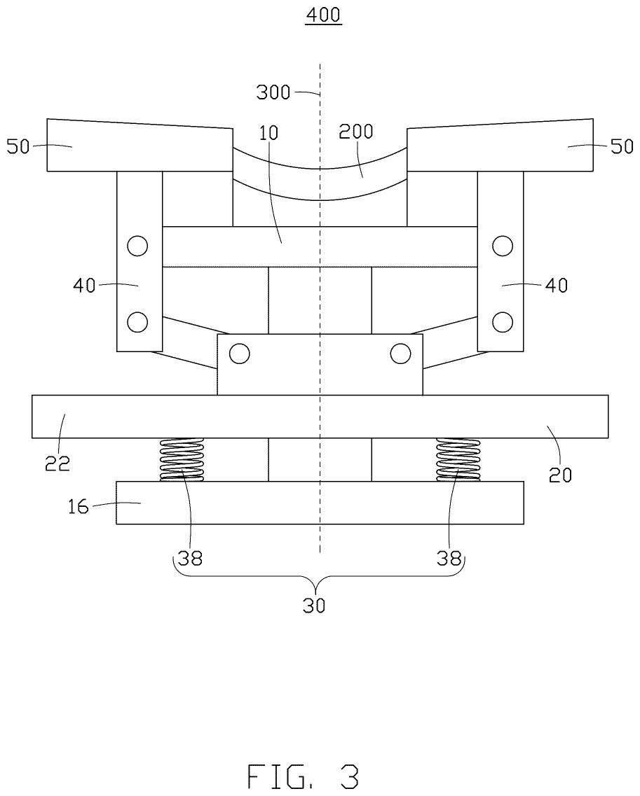

Referring to FIG. 3, a limiting mechanism 400 is provided according to another embodiment of the present disclosure. The limiting mechanism 400 is similar to the limiting mechanism 100 described above. The differences are that the number of crank assemblies 40 are two, and the number of the limiting members 50 are two. The two crank assemblies 40 and the limiting members 50 are symmetrically arranged along a center line 300 of the limiting mechanism 400. The elastic component 30 includes two resetting members 38, and each of the two resetting members 38 is connected between the base 10 and the transmission seat 20 and located on a side of the transmission seat 20 facing away from the bearing portion 12. The resetting members 38, such as springs, are symmetrically arranged along the center line 300 and connected between the second plate 16 and the base plate 22.

Thus, the limiting mechanism 400 can limit the product 200 from both sides. The elastic component 30 with resetting members 38 simplifies the structure and reduces the cost of the limiting mechanism 400. In other embodiments, each of the numbers of the crank assemblies 40 and the limiting members 50 may be three, four, or more, which are arranged symmetrically around the center line 300 and connected to corresponding ends of the crank assemblies 40. The limiting members 50 may have an arcuate side for abutting against the product 200.

The limiting mechanism (100 or 400) provided in the embodiments achieves the limiting function with a simple structure and a small operating space, making the limiting mechanism (100 or 400) suitable to be used in confined spaces. The limiting mechanism (100 or 400) can operate by applying or removing force on the transmission seat 20, saving labor and cost.

Even though information i and advantages of the present embodiments have been set forth in the foregoing description, together with details of the structures and functions of the present embodiments, the disclosure is illustrative only. Changes may be made in detail, especially in matters of shape, size, and arrangement of portion within the principles of the present exemplary embodiments, to the full extent indicated by the plain meaning of the terms in which the appended claims are expressed.

What is claimed is:

1. A limiting mechanism comprising:
a base comprising a bearing portion configured to support a product;
a transmission seat slidably disposed on the base;
an elastic component connected between the base and the transmission seat;
at least one crank assembly rotatably connected to the transmission seat and the base, wherein one end of each of the crank assembly extends to a side of the bearing portion, each of the crank assembly is configured to move together with the transmission seat, thereby causing one end of each of the crank assembly to move closer to or further away from the bearing portion; and
at least one limiting member connected to the end of the crank assembly, wherein each of the limiting member is configured to move with the end of a corresponding one of the at least one crank assembly, thereby limiting the product at the bearing portion.

2. The limiting mechanism of claim 1, wherein the crank assembly comprises a first rod and a second rod, one end of the first rod is rotatably connected to the transmission seat, another end of the first rod is rotatably connected to one end of the second rod, a middle portion of the second rod is rotatably connected to the base, and another end of the second rod extends to the side of the bearing portion and is connected to the limiting member.

3. The limiting mechanism of claim 1, wherein the base further comprises a first plate, a second plate, and a supporting member, the first plate faces and is positioned above the second plate, the supporting member is connected between the first plate and the second plate, the bearing portion is connected to one side of the first plate away from the second plate.

4. The limiting mechanism of claim 3, wherein the transmission seat is slidably disposed on the supporting member, the elastic component is connected between the second plate and the transmission seat, and the crank assembly is rotatably connected to the transmission seat and the first plate.

5. The limiting mechanism of claim 1, wherein the elastic component comprises a fixing rod, a sliding rod, and an elastic element, one end of the fixing rod is connected to the base, the sliding rod is slidably sleeved on another end of the fixing rod, the sliding rod is connected to the transmission seat and extends towards the bearing portion, and the elastic element is disposed within the sliding rod and abuts against the another end of the fixing rod.

6. The limiting mechanism of claim 5, wherein the elastic component further comprises an abutting member, the abutting member is connected to one end of the sliding rod facing the fixing rod, and the abutting member is positioned on one side of the transmission seat away from the bearing portion.

7. The limiting mechanism of claim 1, wherein the elastic component comprises a resetting member, the resetting member is connected between the base and the transmission seat, and the resetting member is positioned on the side of the transmission seat away from the bearing portion.

8. The limiting mechanism of claim 1, wherein the transmission seat comprises a base plate and a connecting plate, the base plate is slidably disposed on the base, and the connecting plate is slidably disposed on the base and connected to one side of the base plate facing the bearing portion.

9. The limiting mechanism of claim 8, wherein the elastic component is connected between the base and the base plate, and the crank assembly is rotatably connected to the connecting plate and the base.

10. The limiting mechanism of claim 1, wherein a side of the limiting member facing away from the crank assembly is inclined in relative to another side of the limiting member.

11. The limiting mechanism of claim 1, wherein the side of the bearing portion away from the transmission seat defines a groove, and the groove is used to fix the product.

12. The limiting mechanism of claim 1, comprising two crank assemblies and two limiting members, wherein the two crank assemblies are symmetrically arranged along a center line of the limiting mechanism, the two limiting members are symmetrically arranged a long the center line and connected to respective ends of the two crank assemblies.
